(19) United States
(12) Patent Application Publication
(10) Pub. No.: US 2009/0201561 A1
(43) Pub. Date: Aug. 13, 2009

(54) IMAGE READING APPARATUS AND CONTROLLING METHOD FOR THE SAME

(75) Inventor: Ho Bin Hwang, Suwon-Si (KR)

Correspondence Address: DLA PIPER LLP US, P. O. BOX 2758, RESTON, VA, 20195, US

(73) Assignee: SAMSUNG ELECTRONICS CO., LTD., Suwon-Si (KR)

(21) Appl. No.: 12/366,908

(22) Filed: Feb. 6, 2009

(30) Foreign Application Priority Data
Feb. 12, 2008 (KR) 10-2008-0012683

(51) Int. Cl. H04N 1/04

(52) U.S. Cl. 358/498; 358/474

(57) ABSTRACT

An image reading apparatus and a controlling method for the same are disclosed. When a paper feeding speed needs to be varied temporarily, the scanning operation is suspended, and the scanning module is advanced in the paper feeding direction by a predetermined distance to a point where the paper feeding speed becomes constant.

### CROSS-REFERENCE TO RELATED APPLICATION

This application claims the benefit of Korean Patent Application No. 2008-0012683, filed on Feb. 12, 2008, in the Korean Intellectual Property Office, the disclosure of which is incorporated herein by reference.

### BACKGROUND OF RELATED ART

1. Field of Relevant Art

The present disclosure relates to an image reading apparatus and a method of controlling the same. More particularly, the present disclosure relates to an image reading apparatus including an automatic document feeder (ADF), and a method of controlling the same, capable of reducing scanning distortion.

2. Description of the Related Art

Generally, an image reading apparatus may be found in products, such as, e.g., a scanner, a copier, a printer, a facsimile machine and a multifunction peripheral (MFP) that combines the functions of the aforementioned apparatuses, and perform scanning of data recorded on a image recording medium, e.g., a sheet of paper.

The scanning method may in a broad sense be categorized in one of a flat bed scanning method and a sheet feed scanning method, one or both of which may be practiced in a particular image reading apparatus.

In a flat bed scanning method, the scanning is performed by moving a scanning module relative to a stationary paper being scanned. This method is adopted, for example, in copiers in such a manner that the paper is placed on a platen glass, across which the scanning module transversely moves to scan the paper.

The sheet feed scanning method on the other hand accomplishes the scanning by moving the paper to be scanned relative to a stationary scanning module. Generally, in scanners and MFPs employing an ADF, the scanning module is kept stationary while the paper is fed by the ADF to move across the scanning module.

As described above, scanners and copiers with an ADF perform scanning by feeding the paper over the stationary scanning module. Typically, in a process often referred to as the ‘page scan,’ the documents are scanned one page at a time with the scanned data temporarily stored in a memory for further processing. During a page scan, however, when the amount of data to be scanned is exceedingly large or when the memory capacity is small, it may become necessary to halt the feeding of the paper in order to process the scanned data and to resume further scanning of the paper after freeing up sufficient memory space.

Distortions of the scanned image may occur during the halting and resumption of the paper feed because while the scanning module reads the data according to a fixed line time interval that assumes a constant paper feed speed, a deceleration and an acceleration of the paper feed speed takes place during the halting and resumption of the feed.

Efforts to address the above heretofore include increasing the memory capacity to a size sufficient to store the entire page worth of data and/or lowering the scanning resolution or definition to reduce the amount of data required to be stored in the memory. More recently, relative reduction of the paper feeding speed has been seen as attempts to minimize the variation in the paper feeding speed.

Unfortunately, however, the reduction in the paper feeding speed may result in slower scanning speeds, and may not completely eliminate the need to halt the paper feeding, and thus scanning during the halt/resumption of the paper feed may still occur.

### SUMMARY OF DISCLOSURE

Consistent with one aspect, an image reading apparatus may comprise an automatic document feeder (ADF) configured to feed a paper along a paper feeding direction; a scanning module configured to scan an image recorded on the paper being fed by the ADF; a driving module couple to, and configure to move, the scanning module; and a control unit configured to control the driving module to move the scanning module in the paper feeding direction when a paper feeding speed at which the paper is fed is varied.

The control unit may be configured to control the scanning module so as to suspend the scanning of the image by the scanning module when the paper feeding speed is varied.

The control unit may be configured to move the scanning module by a distance equal to or greater than a total distance the paper travels during when the paper feeding speed varies.

The total distance the paper travels may be the sum of a deceleration distance and an acceleration distance of the paper.

The control unit may be configured to control the scanning module so as to resume the scanning of the image when the paper feeding speed becomes constant.

The control unit may determine that a temporary variation of the paper feeding speed is required based on data read from the paper exceeding a predetermined amount.

According to another aspect, an image reading apparatus may comprise an automatic document feeder (ADF) configured to feed a paper along a paper feeding direction; a scanning module configured to scan an image recorded on the paper being fed by the ADF; a driving module couple to, and configure to move, the scanning module; and a control unit configured to cause the scanning module to remain stationary when a paper feeding speed at which the paper is being fed is constant, and, when the paper feeding speed is not constant, to stop the scanning module from scanning the image, and to cause the scanning module to be moved in the paper feeding direction by a distance.

The distance may be equal to or greater than the sum of a deceleration distance and an acceleration distance of the paper during when the paper feeding speed is not constant.

The control unit may be configured to cause the scanning module to resume scanning the image after the paper has traveled the sum of the deceleration distance and the acceleration distance.

According to yet another aspect, an image reading apparatus may comprise a scanning module scanning an image recorded on a paper as the paper is fed along a paper feeding direction; and a control unit configured to control the scanning module such that the scanning module remains stationary, and performs scanning of the image, if the paper is being fed at a constant speed, and such that the scanning module stops scanning of the image, and moves by a distance in the paper feeding direction, if the paper is not being fed at the constant speed.

Consistent with even yet another aspect, an image reading method may comprise feeding a paper along a paper feeding direction; determining whether a temporary variation of a paper feeding speed at which the paper is fed is necessary; and moving a scanning module, which scans an image recorded on the paper, in the paper feeding direction if it is determined that the temporary variation of the paper feeding speed is necessary.

The method may further comprise suspending the scanning of the image by the scanning module if it is determined that the temporary variation of the paper feeding speed is necessary.

The step of moving the scanning module may comprise moving the scanning module by a distance equal to or greater than a total distance the paper travels during the temporary variation of the paper feeding speed.

The total distance the paper travels may be determined as the sum of a deceleration distance and an acceleration distance of the paper during the temporary variation of the paper feeding speed.

The method may further comprise resuming the scanning of the image by the scanning module after the paper has traveled the total distance.

The step of determining whether the temporary variation of the paper feeding speed is necessary may comprise comparing an amount of data that had been read with a predetermined value; and determining that the temporary variation of the paper feeding speed is necessary if the amount of data exceeds the predetermined value.

According to even yet another aspect, a method of reading an image recorded on a paper that is fed along a paper feed direction across a scanning module that scans the image may comprise suspending the feeding of the paper; and moving the scanning module in the paper feeding direction from a current location to a new location, the current location corresponding to a location of the scanning module at the time of the suspension of the feeding of the paper.

The method may further comprise suspending scanning by the scanning module upon suspending the feeding of the paper; resuming the feeding of the paper; and resuming the scanning by the scanning module when a position of the paper that were to be scanned at the time of the suspension of the feeding of the paper reaches the new location after resuming the feeding of the paper.

The distance between the new location and the current location may be equal to or greater than a total distance the paper travels from the suspension of the feeding of the paper to the feeding of the paper at a constant speed is resumed.

The total distance the paper travels may be determined as the sum of a deceleration distance the paper travels before stopping after the suspension of the feeding of the paper and an acceleration distance the paper travels before reaching the constant speed after the resumption of the feeding of the paper.

### BRIEF DESCRIPTION OF THE DRAWINGS

Various features and advantages of the embodiments of the present invention will become apparent and more readily appreciated from the following description of the embodiments, taken in conjunction with the accompanying drawings, of which:

FIG. 1 is a perspective view of an image reading apparatus according to an embodiment of the present invention;

FIG. 2 is a perspective view showing a scanning module and a driving module according to an embodiment of the present invention;

FIG. 3 is a side sectional view schematically illustrating the structure of portions of the image reading apparatus shown in FIG. 1;

FIG. 4 is a block diagram illustrating components for controlling the image reading apparatus according to an embodiment;

FIG. 5 is a flow chart of a process to control the image reading apparatus according to an embodiment;

FIG. 6 illustrates the movement of the scanning module according to an embodiment; and

FIG. 7 illustrates controlling of the scanning module in relation to the paper being fed according to another embodiment.

### DETAILED DESCRIPTION OF SEVERAL EMBODIMENTS

Reference will now be made in detail to the embodiments of the present invention, examples of which are illustrated in the accompanying drawings, wherein like reference numerals refer to like elements throughout. Some of the detailed construction and elements are provided to assist in a comprehensive understanding of the embodiments, and may not be required to practice the various aspects of the present invention. Thus, it should be readily apparent that aspects of the present invention may be carried out without those details.

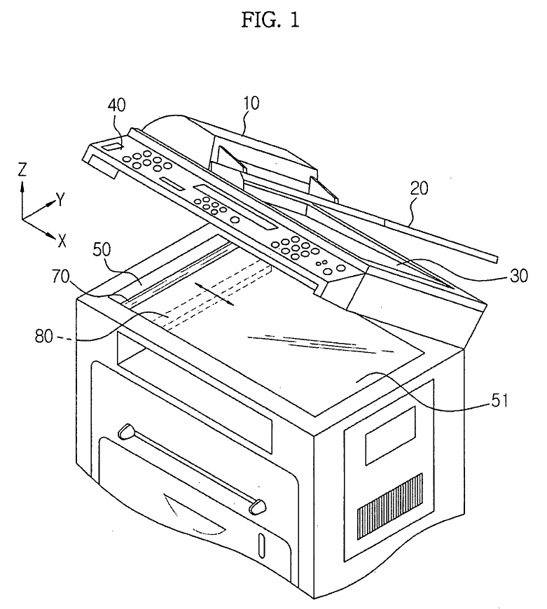

FIG. 1 shows an image reading apparatus according to an embodiment of the present, invention, which may include platen glasses 50 and 51, an automatic document feeder (ADF) 10 and a scanning module 80. The scanning module 80 may move in a direction along the x-axis, and may read a line or lines at a time of the image across a direction along the y-axis direction.

According to the embodiment, the platen glasses 50 and 51 comprises a first platen glass 50 contacting a paper being fed by the ADF 10 and a second platen glass 51 on which a sheet or sheets of paper to be scanned can be manually placed. Preferably, the first and the second platen glasses 50 and 51 are segregated from each other. A display panel 40, which may include various operation keys, may display operational states of the image reading apparatus. Paper sheets stacked on a paper feeding tray 20 are fed to the first platen glass 50 by the ADF 10. The scanning module 80 positioned at the side of the first platen glass 50 opposite the side that contacts the paper, that is, underneath the first platen glass 50, reads the image recorded on the paper. The scanned paper is discharged to a discharging tray 30. A paper guiding member 70 having a sloped surface may be provided between the first and the second platen glasses 50 and 51. The paper guiding member 70 guides a leading end of the paper being passed through the first platen glass 50 toward the discharging tray 30. For scanning an individual sheet of paper, the paper may be placed directly on the second platen glass 51 rather than feed through the ADF 10.

The scanning module 80 reads the image on the stationary paper placed on the second platen 51, as the scanning module moves in the scanning direction, i.e., in the direction along the x-axis, under the second platen glass 51. An initial position of the scanning module 80 may be, e.g., the underside of the first platen glass 50 when scanning a paper fed through the ADF 10 or the underside of the second platen glass 51 when scanning a manually placed stationary paper.

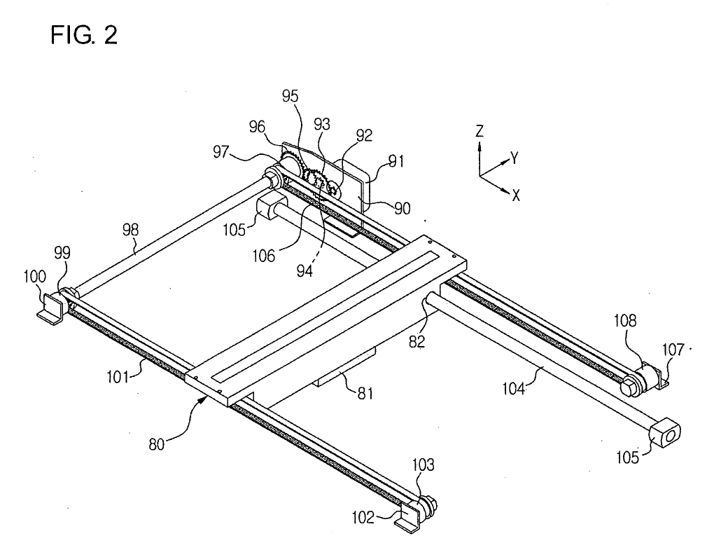

FIG. 2 shows the scanning module and a driving module of the image reading apparatus according to an embodiment. The scanning module 80 may read an image of the paper P (not shown) while moving, e.g., in a sliding manner. The driving module drives the scanning module 80 to move along an axis in the scanning direction.

The scanning module 80 may have the structures found in generally available scanning modules. For example, the scanning module 80 may comprise a light source producing a light, a light reflection member reflecting and focusing the light produced by the light source toward the paper P, a lens unit focusing and/or transmitting optical signals corresponding to read data of the paper P to an image sensor, a plurality of mirrors forming optical paths from the light source up to the lens unit, the image sensor converting the optical signals focused by the lens unit into electric signals, and a frame constituting the outer appearance of the scanning module 80. In one embodiment, a charge coupled device (CCD) sensor that converts an optical signal obtained by scanning the paper into an electric signal may be used as the image sensor. Other known image sensors, e.g., a complementary metal oxide semiconductor (CMOS) sensor can alternatively be employed.

The driving module may according to an embodiment comprise a guide hole 82 formed on the scanning module 80, and a guide shaft 104 inserted in the guide hole 82. The guide hole 82 guides the sliding movement of the scanning module 80 along the guide shaft 104 in the x-axis direction.

According to one embodiment, the guide hole 82 may preferably comprise a sliding bearing (not shown) that may reduce the friction between the guide hole 82 and the guide shaft 104 and allow a smoother movement. Preferably, one guide shaft 104 is disposed in the vicinity of a first timing belt 106. While the scanning module 80 is typically guided by a single shaft 104, any guide holes 82 and guide shaft 104 may be provided. Each end of the guide shaft 104 may be fixed to a main body of the image reading apparatus by a guide shaft holder 105.

The driving module may further comprise first and second timing belts 106 and 101 respectively connected with the corresponding end of the scanning module 80, first and second belt pulleys 97 and 99, each of which may have a serrated outer circumference, for supporting an end of, and for driving, the respective one of the first and the second timing belts 106 and 101, a connection shaft 98 coaxially coupling the first and the second belt pulleys 97 and 99 to each other, a driving motor 91, and a gear train transmitting the driving force from the driving motor 91 to the first belt pulley 97. According to an embodiment, the gear train may comprise a first gear 92 coaxially connected to the shaft of the driving motor 91, and second to fifth gears 93 to 96 connected to the first gear 92. The gear train may be employed to transmit the driving force of the driving motor 91 to the first belt pulley 97 at a reduced rotational speed.

According to an embodiment, the first timing belt 106, the first belt pulley 97 that turns the first timing belt 106, the second timing belt 101, and the second belt pulley 99 that turns the second timing belt 101 may each be formed with a serration on its engaging surfaces. With the increase in the size of the paper P to be scanned, the volume, mass and sliding speed of the scanning module 80 may also be required to increase, increasing the risk of reading error. Engagements between the timing belts 106 and 101 and the belt pulleys 97 and 99 through the serrations may prevent slips during the operation. Since the first and the second belt pulleys 97 and 99 are coaxially interconnected through the connection shaft 98, the sliding speed of both ends of the scanning module 80 can be uniform.

According to the embodiment shown in FIG. 2, the driving force is transmitted to the scanning module 80 through the gear train, the belt pulleys 97 and 99, the timing belts 106 and 101, and the connection shaft 98, making it possible to prevent slippage and to precisely control the position and speed of the scanning module 80.

According an embodiment the driving module may preferably further comprise a first bracket 90 and a second bracket 100. The first bracket 90 connects the first belt pulley 97, the driving motor 91 and the gear train to the main body of the image reading apparatus. The second bracket 100 connects the second belt pulley 99 to the main body.

The other ends of the first timing belt 106 and the second timing belt 101 are supported by the third belt pulley 108 and the fourth belt pulley 103, respectively. The third and the fourth belt pulleys 108 and 103 may also have a serrated outer circumference. The third belt pulley 108 may be connected to the main body of the image reading apparatus by the third bracket 107. The fourth belt pulley 130 may be connected to the main body by the fourth bracket 102.

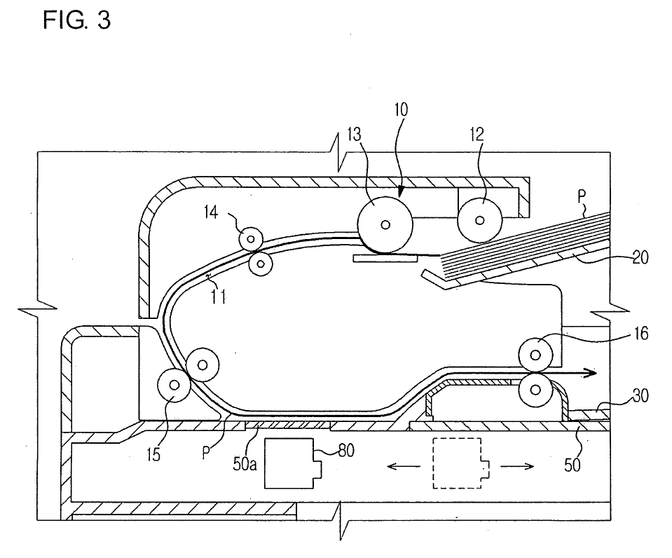

As shown in FIG. 3, an ADF 10 according to an embodiment that may be employed in the above-described image reading apparatus may comprise a pickup roller 12 for picking up the paper P stacked on the paper feeding tray 20, first to third feeding rollers 13, 14 and 15 transferring the paper P picked up by the pickup roller 12 along a paper feeding path 11, and a discharging roller 16 discharging the paper P passed through the scanning operation toward the discharging tray 30. Those rollers 12 to 16 are rotated by at least one motor (not shown) to feed the paper P at a proper speed for the scanning module 80 to scan the paper P.

The paper feeding path 11 may according to an embodiment be substantially in a C-shape, one end of which is connected to the paper feeding tray 20 and the other end to the discharging tray 30. In the paper feeding path 11, an ADF glass 50a is provided on the first platen glass 50 so that the image data recorded on the paper P can be read by the scanning module 80 while the paper P is passing through the paper feeding path 11. The width of the ADF glass 50a is greater than the width of the scanning module 80, allowing the scanning module 80 can move within a predetermined range within the width of the ADF glass 50a.

The scanning module 80 is disposed along the paper feeding path 11, for example, at a lower part of the paper P being fed by the ADF 10 to project a light to the paper P and detect the light reflected from the paper P. In addition, the scanning module 80 may convert the detected light into an electric signal, and may transmit the electric signal to a control unit 200, which may control the overall operation of the image reading apparatus.

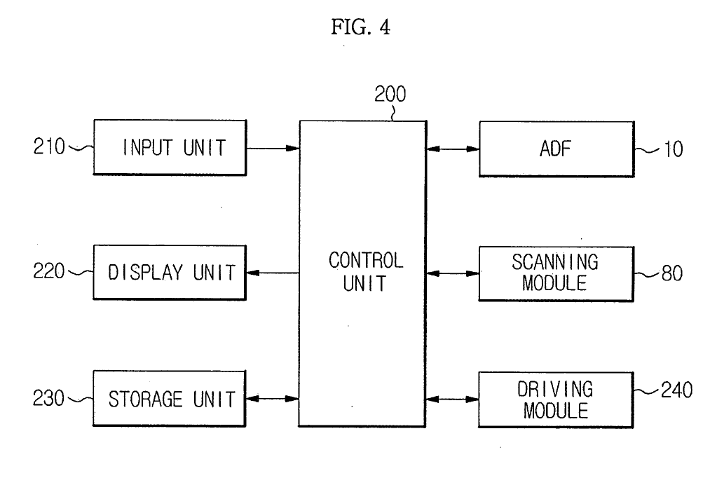

FIG. 4 is a block diagram illustrating the control system of the image reading apparatus according to an embodiment. Referring to FIG. 4, the image reading apparatus may comprise an input unit 210, a display unit 220, a storage unit 230, the ADF 10, the scanning module 80 and the control unit 200.

Through the input unit 210, the operational of the image reading apparatus may be selected by a user, and the user selection may be input to the control unit 200. For example, the user may input a command to initiate a scanning operation through the input unit 210. The user may also select scanning options related to the scanning module 80, such as the resolution, black-and-white or color scanning, or the like, through the input unit 210.

The display unit 220 displays operational states of the image reading apparatus or the scanned image for the user to check.

The storage unit 230 may store various data required for controlling of the image reading apparatus. In addition, the storage unit 230 may comprise a buffer memory to temporarily store the data scanned by the scanning module 80. The control unit 200 may also perform predetermined image processing, such as, for example, gamma compensation, shading compensation, or the like, by retrieving the image data stored in the buffer memory.

The control unit 200 may perform the general control of the image reading apparatus, or may be a dedicated controller for controlling the scanning module 80 and/or the ADF 10 as described herein. The control unit 200 may include, for example, a microprocessor, microcontroller, or the like, that are capable of executing computer instructions to implement the controlling of the relevant operations of the image reading apparatus as described herein, and may also include a microprocessor, e.g., a Pentium™, RISC™-based, or other type of processor, one or more memory devices, which may be for example a random access memory (RAM), a read-only-memory (ROM), or the like, to store the instructions to be executed by the microprocessor or the microcontroller, and to store other data useful in controlling the operation of the image reading apparatus 10. The storage unit 230 may comprise a random access memory (RAM), a programmable read-only-memory (PROM), a flash memory, or the like.

The driving module 240 transfers the scanning module 80 along the scanning direction as previously described.

When the paper feeding speed needs to be temporarily varied during the scanning operation the control unit 200 may stop the scanning operation of the scanning module 80, and may cause the scanning module 80 advance by a predetermined distance in the paper feeding direction. The predetermined distance corresponds to a distance from the beginning to the end of the temporary speed variation, and may vary, e.g., according to the paper feeding speed, the acceleration/deceleration of the scanning module 80, or the like. That is, the scanning module 80 may remain stationary, and scan the paper, during the time the paper is fed and advancing at a constant speed. On the other hand, when the paper feeding speed becomes non-constant, the scanning operation may be suspended, and the scanning module 80 is relocated by the predetermined distance in the paper feeding direction to a point where the paper again advances at a constant paper feeding speed, at which point the scanning module 80 resumes the scanning of the paper.

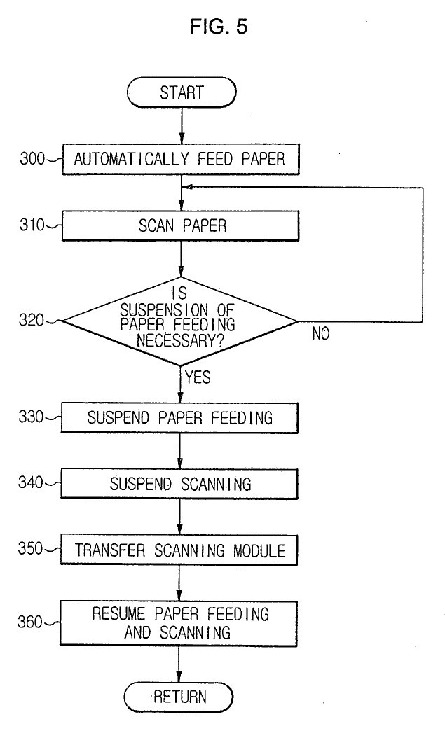

For example, as shown in FIG. 5, the control unit 200 may cause the paper to be fed by the ADF 10 according to the scanning command input through the input unit 210 (operation 300). As the paper is being fed, the control unit 200 scans the image data recorded on the paper using the scanning module 80, and stores the scanned data in the storage unit 230 (operation 310). When the control unit 200 determines that a suspension of the paper feeding is required, for example, because the data size exceeds the memory capacity (operation 320), the control unit 200 suspends the paper feeding being performed by the ADF 10 (operation 330), and also suspends the scanning performed by the scanning module 80 (operation 340). The control unit 200 causes the driving module 240 to transfers the scanning module 80 in the paper feeding direction (operation 350). With the scanning module 80 transferred to the new location, the control unit 200 resumes the paper feeding by the ADF 10, and also resumes the scanning by the scanning module 80 when the paper attains the regular feeding speed (operation 360).

In the above-described embodiment of image reading apparatus, the paper, which is the object to be scanned, is fed by the ADF 10 to pass over the scanning module 80, during which the scanning module 80 performs scanning. When the scanning is performed in this manner, a page scan mode is generally used, in which mode the entire page worth of data is ideally read without a suspension of the paper feeding.

However, for example, when the data size is excessive due to a high scanning resolution or when the memory capacity is insufficient, the paper feeding may need to be temporarily suspended so that the data already scanned may be processed without being lost, and may resume after the processing of sufficient data to free up memory capacity for continued scanning of additional data. Such suspension during the scanning may result in distortion of the scanned image in the section of the paper fed at a speed not constant, such as during the deceleration to stop and/or the acceleration from the stopping of the paper feed. That is, because the scanning module 80 reads the data at a uniform time interval, the paper passing over the scanning module 80 needs to be fed at a constant speed in order to obtain a stable image quality. When the suspension of paper feeding occurs, however, the paper is fed slower than the desired constant speed, an is varying, thereby causing the image distortion. Heretofore, the paper feeding speed as whole was decreased in hopes that such slower feeding speed may minimize the need to suspend the feeding and thus the feeding speed variations so as to reduce the image distortion. Aspects of the embodiments herein disclosed may allow image distortion to be avoided even when some feeding speed variations occur, and may also allow high-definition scanning to be performed without an intentional substantial reduction in the overall scanning speed.

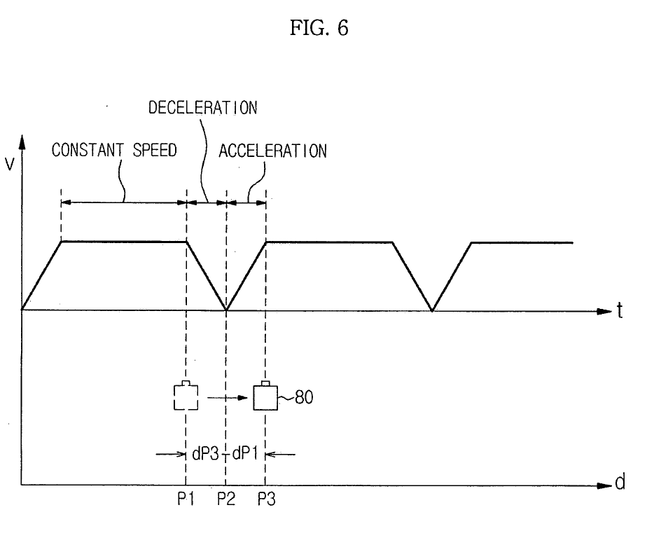

FIG. 6 shows the scanning module being transferred in the paper feeding direction when the paper feeding speed is temporarily varied in the image reading apparatus. Referring to FIG. 6, the x-axis of the plot shown denotes the time t or the distance d while the y-axis denotes the paper feeding speed v. The position P1 indicates the initial position of the scanning module 80 and the location of the position of the paper corresponding to the position of the scanning module at that time. The position P2 indicates the position at which the paper feeding has been stopped and the location of the same position of the paper at that time. The position P3 indicates the position to which the scanning module 80 is transferred and the location of the same position of the paper at that time. The distance between the initial position and the transferred position of the scanning module 80 is ‘dP3-dP1’ as indicated in FIG. 6. In the portion between the positions P1 and P3, the paper P is fed at a varying speed, which may be lower than the desired constant speed, and if the scanning were to continue in the portion, the scanned image may be distorted. According to aspects of the present disclosure, the distortion may be prevented by performing the scanning only while the paper is fed at a constant speed. This can be achieved according to the present disclosure by properly transferring the scanning module 80.

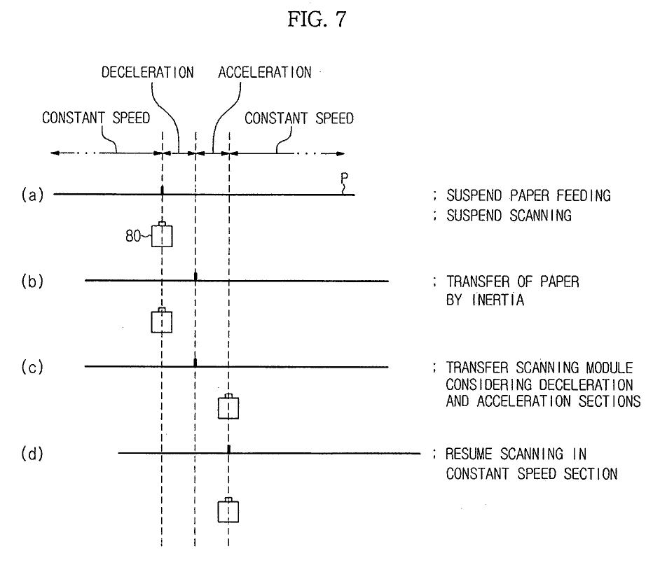

Referring to FIGS. 6 and 7, when the suspension of the paper feeding is required while the paper is fed at the constant speed, the paper feeding by the ADF 10 and the scanning by the scanning module 80 are suspended (as depicted in (a) of FIG. 7). The paper P stops after continuing to move due to inertia by a deceleration portion dP2-dP1 (as depicted in (b) of FIG. 7). The scanning module 80 is transferred by the distance dP3-dP2 which may be the sum of the deceleration portion dP2-dP1 and an acceleration portion dP3-dP2 (as depicted in (c) of FIG. 7). The distance dP3-dP1 may be determined to be the same as or greater than the sum of the deceleration section and the acceleration portions to compensate for the deceleration and acceleration of the paper. The distances of the deceleration and acceleration portions can easily be calculated from the paper feeding speed. When the scanning module 80 is transferred forward, the scanning module 80 is directed to a front part of the paper, that is, the part of the paper that had already been scanned. After the condition that necessitated the temporary suspension of the paper feed, e.g., after a sufficient amount of previously scanned data is processed, the paper feeding by the ADF 10 may be resumed. When the scanning module 80 is placed at the position P1 of the paper, that is, the position of the paper the scanning was previously suspended, the scanning by the scanning module 80 is resumed (as depicted in (d) of FIG. 7). Since the transferred distance of the scanning module 80 is the same as or greater than the sum of the deceleration and acceleration distances of the paper, the paper feeding speed will be returned to the constant speed when the position P1 of the paper reaches the scanning module 80. It should be noted that while in the above description, suspension of scanning during when the paper feeding speed becomes slower that the constant speed for normal scanning, the suspension of scanning and advancing of the scanning module 80 can also be applied when the feeding speed temporarily exceeds the normal feeding speed. Thus, by suspending the scanning operation in the portion where the paper feeding speed is not constant, such as, either decreasing or increasing, the image distortion can be prevented.

According to aspects of the present disclosure, during a temporary suspension and resumption of paper feeding, the scanning module 80 is transferred in the paper feeding direction by a distance that is the same as or greater than the total distance the paper travels during the deceleration and acceleration of the paper, such that the scanning can be performed as if the paper feeding speed had been constant. As a result, distortion of the scanned image can be prevented. Moreover, the high-resolution scanning can also be performed at a higher speed.

As can be appreciated from the above description, according to the aspects of the present disclosure, when variation of the paper feeding speed is temporarily required, the scanning operation is suspended, and is resumed after the paper feeding speed returns to the constant speed with the scanning module advanced in the paper feeding direction by a predetermined distance that accounts for the distance the paper travels during the time of the temporary variation of paper feeding speed. By this, distortion of the scanned image can be reduced, and a high-definition scanning is made possible at a high speed.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image reading apparatus, comprising:
an automatic document feeder (ADF) configured to feed a paper along a paper feeding direction;
a scanning module configured to scan an image recorded on the paper being fed by the ADF;
a driving module couple to, and configure to move, the scanning module; and
a control unit configured to control the driving module to move the scanning module in the paper feeding direction when a paper feeding speed at which the paper is fed is varied.

2. The image reading apparatus according to claim 1, wherein the control unit is configured to control the scanning module so as to suspend the scanning of the image by the scanning module when the paper feeding speed is varied.

3. The image reading apparatus according to claim 1, wherein the control unit is configured to move the scanning module by a distance equal to or greater than a total distance the paper travels during when the paper feeding speed varies.

4. The image reading apparatus according to claim 3 wherein the total distance the paper travels is the sum of a deceleration distance and an acceleration distance of the paper.

5. The image reading apparatus according to claim 4, wherein the control unit is configured to control the scanning module so as to resume the scanning of the image when the paper feeding speed becomes constant.

6. The image reading apparatus according to claim 1, wherein, when data read from the paper exceeds a predetermined amount, the control unit determines that a temporary variation of the paper feeding speed is required.

7. The image reading apparatus according to claim 1, wherein the control unit is configured to cause the scanning module to remain stationary when a paper feeding speed at which the paper is being fed is constant, and, when the paper feeding speed is not constant, to stop the scanning module from scanning the image, and to cause the scanning module to be moved in the paper feeding direction by a distance.

8. The image reading apparatus according to claim 7, wherein the distance is equal to or greater than the sum of a deceleration distance and an acceleration distance of the paper during when the paper feeding speed is not constant.

9. The image reading apparatus according to claim 8, wherein the control unit is configured to cause the scanning module to resume scanning the image after the paper has traveled the sum of the deceleration distance and the acceleration distance.

10. An image reading apparatus, comprising:
a scanning module scanning an image recorded on a paper as the paper is fed along a paper feeding direction; and
a control unit configured to control the scanning module such that the scanning module remains stationary, and performs scanning of the image, if the paper is being fed at a constant speed, and such that the scanning module stops scanning of the image, and moves by a distance in the paper feeding direction, if the paper is not being fed at the constant speed.

11. A method of reading an image recorded on a paper as the paper is fed along a paper feed direction across a scanning module that scans the image, comprising:
suspending the feeding of the paper; and
moving the scanning module in the paper feeding direction from a current location to a new location, the current location corresponding to a location of the scanning module at the time of the suspension of the feeding of the paper.

12. The method of reading the image according to claim 11, further comprising:
suspending scanning by the scanning module upon suspending the feeding of the paper;
resuming the feeding of the paper; and
resuming the scanning by the scanning module when a position of the paper that were to be scanned at the time of the suspension of the feeding of the paper reaches the new location after resuming the feeding of the paper.

13. The method of reading the image according to claim 12, wherein a distance between the new location and the current location is equal to or greater than a total distance the paper travels from the suspension of the feeding of the paper to the feeding of the paper at a constant speed is resumed.

14. The method of reading the image according to claim 12, wherein the total distance the paper travels is determined as the sum of a deceleration distance the paper travels before stopping after the suspension of the feeding of the paper and an acceleration distance the paper travels before reaching the constant speed after the resumption of the feeding of the paper.

15. The method of reading the image according to claim 11, comprising:
comparing an amount of the scanned data with a predetermined value; and
suspending the feeding of the paper if the amount of data exceeds the predetermined value.
